(19) United States
(12) Patent Application Publication
(10) Pub. No.: US 2007/0226321 A1
(43) Pub. Date: Sep. 27, 2007

(54) Image based document access and related systems, methods, and devices

(75) Inventor: Michael Bengtson, Lombard, IL (US)

Correspondence Address: FISH & NEAVE IP GROUP;ROPES & GRAY LLP, ONE INTERNATIONAL PLACE, BOSTON, MA, 02110-2624, US

(73) Assignee: R R DONNELLEY & SONS COMPANY, Chicago, IL (US)

(21) Appl. No.: 11/388,814

(22) Filed: Mar. 23, 2006

(51) Int. Cl. G06F 15/16

(52) U.S. Cl. 709/219

(57) ABSTRACT

Methods, systems, and devices for providing to a user information associated with an acquired image are described. A method may include acquiring an image from a printed item, and identifying a virtual rendition of the item based on the content of a portion of the acquired image. A method may include selecting a feature in the acquired image, and providing information based on the feature.

### BACKGROUND

Improvements in data communications and storage capabilities have enabled the distribution and collection of vast amounts of electronic media content. Such media content has increasingly included electronic versions of physical documents such as books, magazines, newspapers, newsletters, manuals, guides, references, articles, reports, labels and other printed matter. Other electronic media content such as advertisements, packaging, banners, pamphlets, pop-up images, signs, forms, posters and commerce related documents have emerged.

The Internet has become a significant source of electronic documents. However, the amount of electronic documents and other media content has become so great that search and retrieval of such content is often inefficient at best and futile at worst. Certain search tools, Internet portals, and applications exist that enable users to perform searches of websites and other databases.

One problem is that existing search mechanisms require users to submit search terms in the form of text to locate or retrieve a desired electronic document. Accordingly, there is a need to enable an efficient search and retrieval of an electronic document without the need to perform cumbersome text entry, especially using a compact and portable communications device.

Another problem is that owners of printed documents have no convenient mechanism to obtain an electronic version of such documents. Accordingly, there is a need to enable a document owner to retrieve an electronic version of a printed document in an efficient and reliable manner.

There is also a desire to limit access to certain electronic documents based, for example, on regulatory rules or for commercial reasons. Accordingly, there is a need to restrict access to certain electronic documents based on certain rules.

A further problem is that viewers of certain documents or physical items may desire additional or supplemental information related to the physical item. Thus, there is need to provide users that have access to certain physical documents or items with the ability to immediately have access to supplemental or related sources of information.

### BRIEF DESCRIPTION OF THE FIGURES

FIG. 1 illustrates a system which includes a client system and a server, with the server being connected through a network to the client system in accordance with the principles of the invention.

FIG. 2 is a functional block diagram of a wireless communication device (“WCD”) in accordance with the principles of the invention.

FIG. 3 is a functional block diagram showing various applications within a client WCD in accordance with the principles of the invention.

FIG. 4 is a functional block diagram of a server device and application in accordance with the principles of the invention.

FIG. 5 is a flow chart of a method for using a camera phone to retrieve a URL associated with a printed item, in accordance with the principles of the invention.

FIG. 6 depicts a camera phone used to order an item from a catalog, in accordance with the principles of the invention.

FIG. 7 is a flow chart of a method for adding a publication and associated URL's to a Print-Link system in accordance with the principles of the invention.

FIG. 8 is a flow chart of a method for uniquely identifying a printed item.

FIGS. 9A-9B depict an example of the information input to a printed item identification process which uses significant words and the coordinates of the location of the words in an image, in accordance with the principles of the invention.

FIG. 10 is a flow chart of an exemplary registration process whereby a user adds an electronic document to a virtual library in accordance with the principles of the invention.

FIG. 11 is a flow chart of a method for providing a window containing an electronic version of a printed item in accordance with the principles of the invention.

FIG. 12 shows a printed item and window displaying an electronic version of a portion of the page in accordance with the principles of the invention.

FIGS. 13A and 13B show a printed item and an electronic version of the printed item, respectively, in accordance with the principles of the invention.

### DETAILED DESCRIPTION OF THE INVENTION

The invention may provide methods and systems for providing to a user information associated with an acquired image. A method in accordance with the principles of the invention may include acquiring an image from a printed item, identifying a virtual rendition of the item based on the content of a portion of the acquired image, selecting a feature in the acquired image, and providing the information based on the feature.

A system in accordance with the principles of the invention may include an image acquisition device configured to acquire an image from a printed item. The image acquisition device may be configured to allow a user to select a feature in the acquired image. The system may further include a database that stores a virtual rendition of the image from the printed item and a processor configured to identify the virtual rendition based on at least a portion of the acquired image.

The invention may provide methods and systems for identifying a printed item based on textual information acquired from a printed item. A method in accordance with the principles of the invention may include identifying in the textual information at least one word, comparing a significance of the word with textual information from documents stored in a database and containing a virtual rendition of the printed item, and identifying a document that contains the printed item based on the comparison.

A system in accordance with the principles of the invention may include a database storing electronic renditions of printed items, an image acquisition device configured to acquire an image of the printed item, and a processor configured to receive the acquired image and identify textual information in the acquired image. The processor may be configured to: (1) determine an attribute of a word in the identified textual information; (2) compare the determined attribute with an attribute associated with an electronic rendition of a printed item stored in the database and (3) identify an electronic rendition of the printed item in the database.

The invention may provide methods and systems for controlling user access to an electronic library of printed documents. A method according to the principles of the invention may include receiving a user registration; receiving information that identifies a physical document; determining, based on the received information and the user registration, whether a user has rights to access an electronic document corresponding to the physical document; if the user has rights, identifying, based on the received information, the electronic document in the electronic library that corresponds to the physical document; and providing to the user access to a copy of the electronic document.

A system according to the principles of the invention may include a database configured to store an electronic copy of a physical document and a server configured to receive from a client registration information and information that identifies a physical document. The server may be configured to determine, based on the received information and the client registration, whether the client has rights to access an electronic copy of the identified physical document and, if the client has the rights, provide to the user access to the electronic document.

The invention may provide methods and systems for controlling user access to an electronic library of printed documents. A method in accordance with the principles of the invention may include acquiring visual information from an area of the image, accessing a database having stored therein a virtual rendition of the acquired image area or of the printed item associated with the visual information, identifying in the database the virtual rendition, based on textual information in the visual information, and displaying the virtual rendition. The method may include acquiring visual information from the item; using the visual information, identifying in a database an electronic rendition of the image; and displaying the electronic rendition.

A system in accordance with the principles of the invention may include an image acquisition device acquiring the image, a database storing an electronic rendition of the image, a processor identifying in the database the electronic rendition, based on textual information in the acquired image, and a display displaying the electronic rendition.

The invention may provide methods and systems for providing user access to electronic images of a physical text based on user ownership of the physical text. A method in accordance with the principles of the invention may include (a) receiving a request for access to one or more electronic images of a physical text in which the request identifies the user submitting the request; (b) confirming user ownership of the physical text based on the user identity; (c) consulting one or more access rules that define an amount of content in electronic images of the physical text that can be provided to the user based on the user's ownership of the physical text; and (d) providing user access to the one or more electronic images of the physical text in accordance with the one or more access rules. The defined amount of content for users who own the physical text is greater than an amount of content that may otherwise be provided to users who do not own the physical text.

Apparatus in accordance with the principles of the invention may include (a) means for receiving a request from a user to access one or more electronic images of a physical text, wherein the request identifies the user; (b) means for confirming user ownership of the physical text based on the user's identity; (c) means for consulting one or more access rules that define an amount of content in electronic images that can be provided to the user based on the user's ownership of the physical text; and (d) means for providing user access to the one or more requested electronic images in accordance with the one or more access rules. The defined amount of content for users who own the physical text is greater than an amount of content that may otherwise be provided to users who do not own the physical text.

A computer implemented method in accordance with the invention may include processing a request from a user to access an electronic version of a physical work stored in a data storage, wherein the data storage has electronic versions of a physical works stored therein, the electronic versions of the physical works comprising images of the physical works that, when displayed to the user, appear the same as the physical works; determining the user's ownership of the physical work; and based on the user's ownership of the physical work, providing the user with access to the electronic version of the physical work.

The invention may provide methods and systems for providing a central database with electronic images of physical texts and enabling access thereto by multiple users. A method in accordance with the principles of the invention may include (a) acquiring images of pages of physical texts in which identifying information is associated with the images to identify the physical texts from which the images are acquired; (b) storing the page images and the associated identifying information in the central database; (c) receiving information indicating a user's ownership of a particular physical text; and (d) enabling the user to access page images of the particular physical text in the central database based on the user's ownership of the physical text.

The invention may provide methods and systems for electronically searching a user-personalized library of content. A method in accordance with the invention may include (a) receiving one or more search terms from a user having an electronically-searchable personalized library of content; (b) electronically searching the full text of the user's personalized library for pages of content that match the search terms to produce search results; (c) providing the search results to the user; (d) receiving a search result selection from the user; and (e) providing to the user an image of a page of content in the user's personalized library based on the user's search result selection.

The invention may provide methods and systems for preparing a user-personalized library of content for electronic searching. A method in accordance with the principles of the invention may include (a) acquiring a general library of content that includes images and corresponding text of pages of content; (b) preparing a page image database comprised of the images of pages of content; (c) preparing a text searchable database comprised of the corresponding text of pages of content; and (d) receiving from a user a selection of content in the general library to form a user-personalized library of content that the user can electronically search using the text searchable database.

The invention may provide methods and systems for electronic searching of a user-personalized library of content. A computer system in accordance with the principles of the invention may include a search server in communication with a database server, in which the database server is configured with a general library of content that is accessible to multiple users, the general library including (1) a page image database containing images of pages of content and (2) a text searchable database containing text and identifying information indicating the page images in the page image database that contain the text, the search server being configured with a search engine comprised of computer-implemented instructions that enable the search server to receive one or more search terms from a user having established a personalized library within the general library of content, search the full text of the user's personalized library for pages of content that match the search terms, provide the results of the full text search to the user for selection by the user, and provide to the user a page image from the page image database based on the user's search result selection.

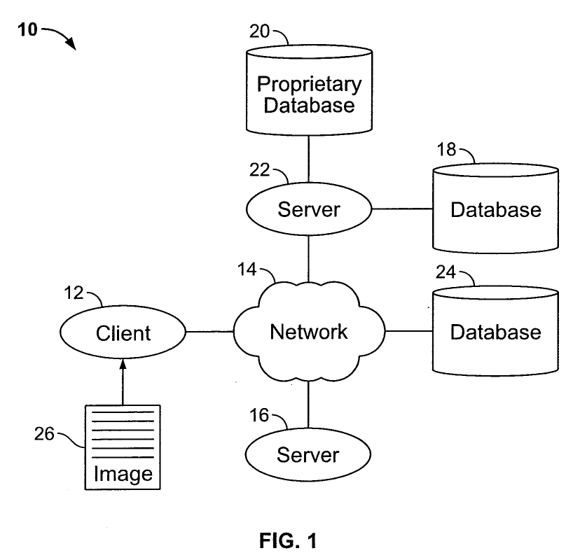

To provide an overall understanding of the invention, certain illustrative embodiments will now be described with reference to FIGS. 1-13B. It will be understood by one of ordinary skill in the art that the systems, methods, and devices shown and described herein can be adapted and modified for other suitable applications and that such other additions and modifications will not depart from the scope hereof.

FIG. 1 shows illustrative system 10, which includes client system 12 and a server 16, such as a server of a trusted party, for example, an internet server provider or a wireless phone service provider, with server 16 being connected through network 14, such as the Internet, a local area network (LAN), or a wide area network (WAN), to client system 12. (Client system 12 as shown in FIG. 1 is to be understood as being representative of a plurality of client systems 12 that can communicate with server 16 or with one another via server 16.)

System 10 may also include additional servers, for example server 22, which may be a publishing company's server. Server 22 connects to database 18, maintained by Server 22, for storing electronic copies of physical texts and pictures. Additionally, server 22 may connect to proprietary database 20 maintained by server 22 for securely storing user identities and user data. In some embodiments of the invention, system 10 include may include additional databases, such as database 24, which may be accessible through network 14. Server 16 may communicate with Server 22, and server 16 and 22 may access the database 24. Client 12 may send an image 26 to a server to request an electronic version of a document or an associated URL.

For the depicted system, client system 12 can be any suitable computer system such as a PC workstation, a handheld computing device, a wireless communication device (“WCD”), or any other such device, equipped with network client software capable of accessing a network server and interacting with server 16 to exchange information with server 16. In some embodiments of the invention, client 12 may be an image capturing device, which may be handheld, such as a scanner or a camera. The network client software may be a web client, such as a web browser that may include the Netscape Navigator web browser, the Microsoft Internet Explorer web browser, the Lynx web browser, the Safari web browser, or a proprietary web browser, or web client that allows the user to exchange data with a web server, an ftp server, a gopher server, or same other type of network server.

Optionally, client 12 and server 16 may rely on an unsecured communication path, such as Internet 14, for accessing services on remote server 16. To add security to such a communication path, the client and the server can employ a security system, such as any of the conventional security systems that have been developed to provide to the remote user a secured channel for transmitting data over the Internet. One such system is the Netscape secured socket layer (SSL) security mechanism that provides to a remote user a trusted path between a conventional web browser program and a web server.

Server 16 may be supported by a commercially available server platform, such as a Sun Sparc™ system running a version of the Unix operating system and running a server capable of connecting with, or transferring data between, any of the client systems. Server 16 may be a search and advertisement engine that generates and serves search pages to clients 12. In the illustrative embodiment shown in FIG. 1, server 16 may include a web server, such as the Apache web server or any suitable web server. The operation of the web server component at the server can be understood more fully from Laurie et al., Apache: The Definitive Guide, O'Reilly Press (1997).

The architecture and components of server 16 may be different for different embodiments of the invention. For example, the web server may have built in extensions, typically referred to as modules, to allow the server to exchange information with the client and to operate on such information, or the web server may have access to a directory of executable files, each of which files may be employed for performing the operations, or parts of the operations, such as files required to create and encrypt ID's and data, as those described herein.

A software system suitable for configuring the computer hardware of client 12 and server 16 to operate as a system according to the invention may include a client process. The client process can be a computer program operating on client system 12 that is capable of downloading and responding to computer files served by server 16. In particular, the client process can be a browser program that is capable of forming one or more connections to an hypertext transfer protocol (“HTTP”) server process for transferring pages from the HTTP server process to the client process. Such a browser process can be the Netscape Navigator browser process, the Microsoft Explorer browser process, the Safari browser process, or any other conventional or proprietary browser process capable of downloading pages and information files, such as multimedia files, generated by server 16.

The client process may form one or more connections to an HTTP server listener process. The HTTP server process can be any suitable server process including the Apache server. Suitable servers are known in the art and are described in Jamsa, Internet Programming, Jamsa Press (1995), the teachings of which are hereby incorporated herein by reference. In one embodiment, the HTTP server process serves HTML pages representative of search requests to client processes making requests for such pages. An HTTP server listener process can be an executing computer program operating on server 16 which monitors a port, and listens for client requests to transfer a resource file, such as a hypertext document, an image, audio, animation, or video file from the server's host to the client process host. In one embodiment, the client process employs HTTP, wherein the client process transmits a file request that specifies a file name, an internet location (host address), and a method or other proprietary or standard protocol suitable to retrieve the requested file. The HTTP server listener process detects the client request and passes the request to the executing HTTP server processors, such as the HTTP server process. According to one embodiment, a plurality of HTTP server processes can be executing on server 16 simultaneously. The HTTP server processors can pass the file request (typically in round-robin style) until an HTTP server process is identified that is available to service the client's request.

In some embodiments of the invention, the HTTP server process that is available to service the request may cause a server temporal process to be forked-off. The server temporal process receives the client's request and processes it to generate, or provide, a page signal to be served to the client. In one embodiment, the server temporal process is a non-parsed header CGI script that produces an HTML page that is passed to the client process. The client process will decode the page signal and display to the participant.

Continuing with the example described above, the HTML page served by the server temporal process to the client process will be processed by the client process (which may be the browser program) to generate a graphical image of the page being requested by the participant. The participant can submit information to the server that can be used to identify a link or other reference. The server temporal process can create a log file in which the server temporal process stores a signal that identifies the participant that has submitted the reference and the reference identification information provided by the participant. The log file, or a database, can be generated by a CGI Script or any other suitable technique, including any of the techniques described in Graham, HTML Sourcebook, Wiley Computer Publishing (1997) the teachings of which are hereby incorporated herein by reference. In some embodiments of the invention, the server temporal process may direct the storage of this information within the log file. Accordingly, the log file can act as a database that stores the titles of references, names of products or other identifying information. In some embodiments of the invention, the log file can be preloaded with a list of those references already known as relevant to the subject matter of the search. In either case the file can be sent to a daemon that can store the file information in a database for later analysis.

In some embodiments of the invention, client system 12 and/or server system 16 may include a data processing system that can comprise a micro-controller system. The micro-controller can comprise any of the commercially available micro-controllers including the 8051- and 6811-class controllers. The micro-controller system may execute programs for implementing image processing functions. In some embodiments of the invention, client system 12 and/or server system 16 may include a data processing system that can include signal processing systems for performing the image processing. These systems can include any of the digital signal processors (DIPS) capable of implementing the image processing functions described herein, such as the DIPS based on the TMS320 core including those sold and manufactured by the Texas Instruments Company of Austin, Tex.

Databases 18, 20, and 24 can include any suitable database system or systems, including commercially available databases, and can be a local or distributed database system. The design and development of suitable database systems are described in McGovern et al., A Guide To Sybase and SQL Server, Addison-Wesley (1993). Databases 18, 20, and 24 can be supported by any suitable persistent data memory, such as a hard disk drive, DVD, CD, RAID system, tape drive system, or any other suitable system. In system 10, databases 18 and 20 are shown as being separate from each other and from server system 22. However, it will be understood by those of ordinary skill in the art that in other embodiments the databases 18 and 20 may be integrated into a single database, and that database 18 and/or database 20 can be integrated into server system 22.

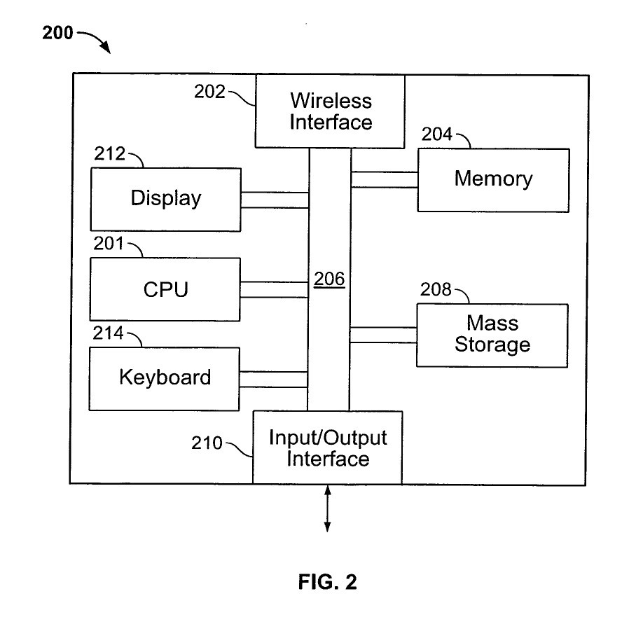

FIG. 2 shows a functional block diagram of illustrative WCD 200. WCD 200 may be client 12 (shown in FIG. 1), or may represent server 16, server 22, or any other suitable server. WCD 200 may be a cellular telephone, smart phone, camera phone, portable digital assistant (“PDA”), compact portable computer, computer tablet, television/satellite/cable remote control unit, PCMCIA card, or like wireless-capable computing device. WCD 200 is preferably compact, handheld, mobile, and includes camera 216. WCD 200 includes central processing unit (“CPU”) 201, wireless interface unit 202, memory 204, interconnect bus 206, display 212, and keypad 214.

CPU 201 may include a single microprocessor or a plurality of microprocessors for configuring WCD 200 as a multi-processor system. Memory 204 may include a main memory (not shown) and a read only memory (not shown). The main memory may include dynamic random access memory (DRAM) and high-speed cache memory. In operation, the main memory stores at least portions of instructions and data for execution of applications by CPU 201.

WCD 200 may also include mass storage 208. Mass storage 208 may include one or more compact disk drives, tape drives or optical disk drives, memory cards, memory sticks, smart cards, and/or non-volatile memory storage, and like devices, for storing data and instructions for use by the CPU 201. At least one component of mass storage system 208, preferably in the form of a memory chip or disk drive, stores an interactive program guide (“IPG”) and/or IPG and associated program information. According to one example, the IPG may include the menu display typically available to a cell phone user. Mass storage system 208 may include one or more drives for various portable media, such as a flash memory card, a jump drive, a minidisc, a compact disc read only memory (CD-ROM), a DVD, or an integrated circuit non-volatile memory adapter (e.g., PC-MCIA adapter) to input and output data and code to and from WCD 200.

WCD 200 may include one or more input/output interfaces for communications, shown by way of example, as data interface 210, for data communications. Data interface 210 may be a modem, an Ethernet card or any other suitable data communications device. WCD 200 may include one or more wireless interface units such as unit 202. Each such wireless interface may include one or more transceivers and/or wireless modems to facilitate wireless communications, including IR communications, with another wireless device and/or wireless network such as a public land mobile network (PLMN).

In certain implementations, data interface 210 may provide a link to a network, such as an intranet, extranet, or the Internet, either directly or through another external interface and/or device. The communication link to the network may be, for example, optical, wired, or wireless (e.g., via satellite or cellular network).

WCD 200 may include an interconnect bus 206 for interconnection with a local display 212 and keypad 214 or the like and thus serve as a local user interface for programming and/or data retrieval purposes.

WCD 200 may run a variety of application programs and store associated data in a database of mass storage system 208. One or more such applications may enable the receipt and delivery of messages to enable operation as a remote control device, IPG, and/or other media content control/interface device.

The WCD 200 may include a camera. In various embodiments, the camera can generate a file in any format, such as the GIF, JPEG, TIFF, PBM, PGM, PPM, EPSF, X11 bitmap, Utah Raster Toolkit RLE, PDSNICAR, Sun Rasterfile, BMP, PCX, PNG, IRIS RGB, XPM, Targa, XWD, PDF possibly PostScript, and PM formats on workstations and terminals running the X11 Window System or any image file suitable for import into the data processing system 12.

While WCD 200 typically includes components optimized for compact, lightweight, and mobile use, the components contained in WCD 200 may be similar to those typically found in a general purpose computer system which may be employed within cellular telephones, PDA's, servers, workstations, personal computers, network terminals, and the like. These components are intended to represent a broad category of such computer components that are well known in the art.

WCD 200 may be a single device with an integrated display, for example an LCD display. The device may also include a keypad, such as the types commonly employed with personal digital assistants and cellular telephones. The keypad can provide the user with an interface for operating the device. The device may also include an interactive display, such as a touchpad, which allows the user to select elements or links on the display. Buttons and/scrolling wheels can also be included, as are commonly found on PDA's and cellular telephones. In alternative embodiment, WCD 200 can include an external monitor and/or keyboard, such as is used with a conventional workstation. The monitor could be a CRT monitor, an LCD monitor, or any other suitable type of display.

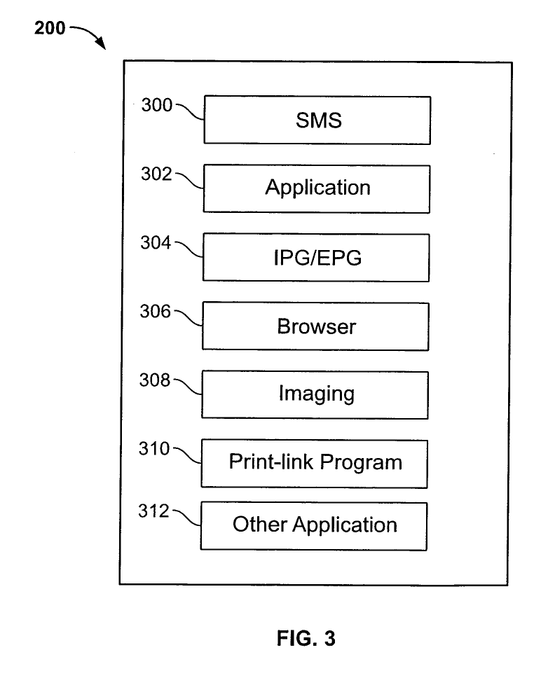

FIG. 3 is a functional block diagram showing various applications, which may include executable code, computer programming and/or other applications, that may operate within WCD 200, and may include Short Message Service (“SMS”) application 300, media content provider interaction program 302, IPG or electronic program guide (“EPG”) 0 application 304, World Wide Web (“WWW”) browser (“Web browser”) 306, imaging program 308, “Print-Link” program 310, as described in further detail below, and/or any other application 312 capable of interacting with a media content provider and/or web server.

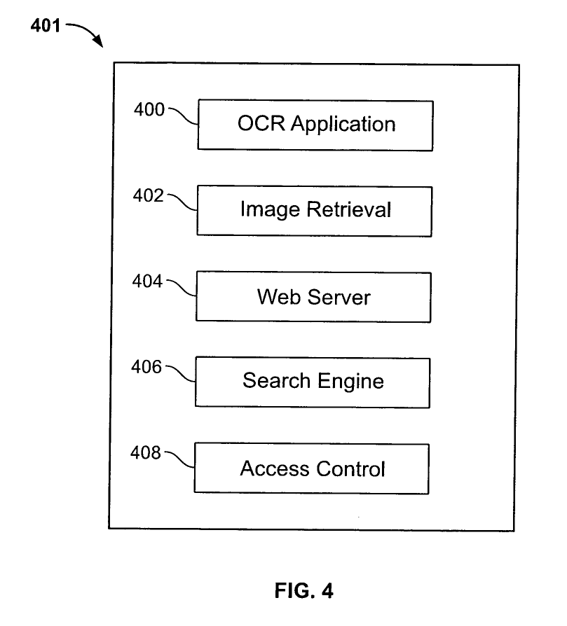

FIG. 4 is a functional block diagram of an illustrative suite 401 of applications, which may include executable code, computer programming and/or other applications that may operate on one or more of servers 16 and 22 (shown in FIG. 1). The applications may include OCR application 400, image retrieval application 402, web server 404, search engine 406, access control application 408, and/or any other application capable of interacting with a client device, another server, and/or a database. In some embodiments, the client 12 may function as a server, and one or more of the applications in FIG. 4 may be present in client 12.

Although FIGS. 2, 3 and 4 show various elements and applications as functional block elements, it will be apparent to one of ordinary skill in the art that the elements and applications can be realized as computer programs or portions of computer programs that are capable of running, as appropriate, on WCD 200, client 12, and servers 16 and 22, to thereby configure WCD 200, client 12, and servers 16 and 22 perform the functions described herein.

Print-Links

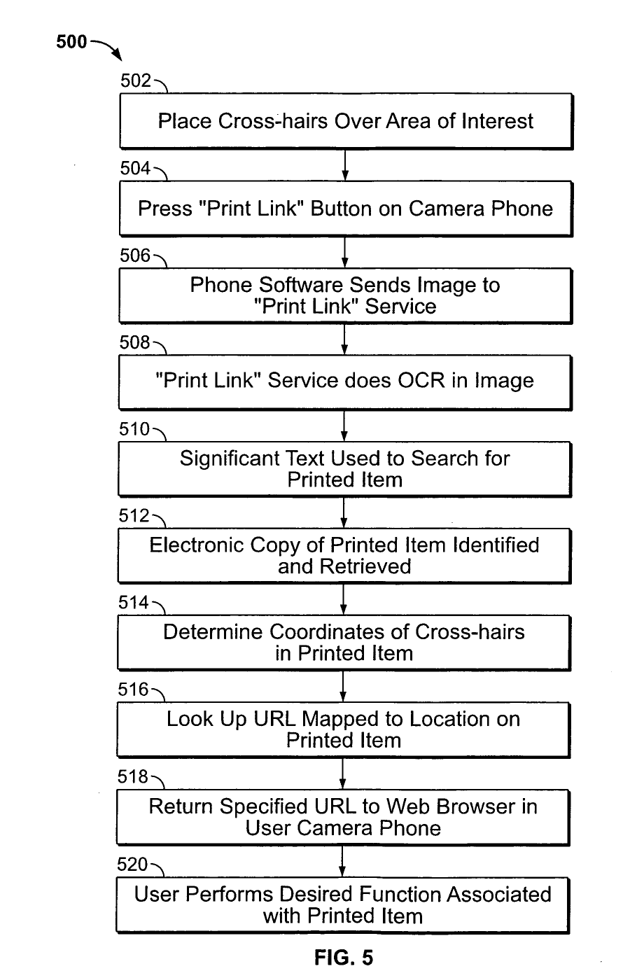

FIG. 5 shows a flowchart of illustrative method 500 for using a device such as WCD 200 (shown in FIG. 2) to retrieve a URL associated with a printed item. The device will be referred to as a camera phone for the purpose of illustration. The camera phone may have a camera that may be focused on an area of interest of the printed item. The camera phone may have a screen that may display an image received by the camera. The screen may be configured to display information received from a server such as 22 (shown in FIG. 1). The screen may display information generated by an IPG or EPG to enable the user to process, position or manipulate the image on the screen, or to position the camera with respect to the item.

As shown in method 500, the user may place cross-hairs of the display over a selected portion of the item (step 502). In some embodiments of the invention, the camera phone may include a “Print-Link” button. When a user presses the “Print-Link” button on the camera phone (step 504), the camera takes a picture of the portion, and software preloaded onto the phone sends the image to a “Print-Link” service. The image may be sent to the service over a wireless telephone network or a wireless internet network, and may be transmitted using any suitable protocol, including CDMA, TDMA, and GSM.

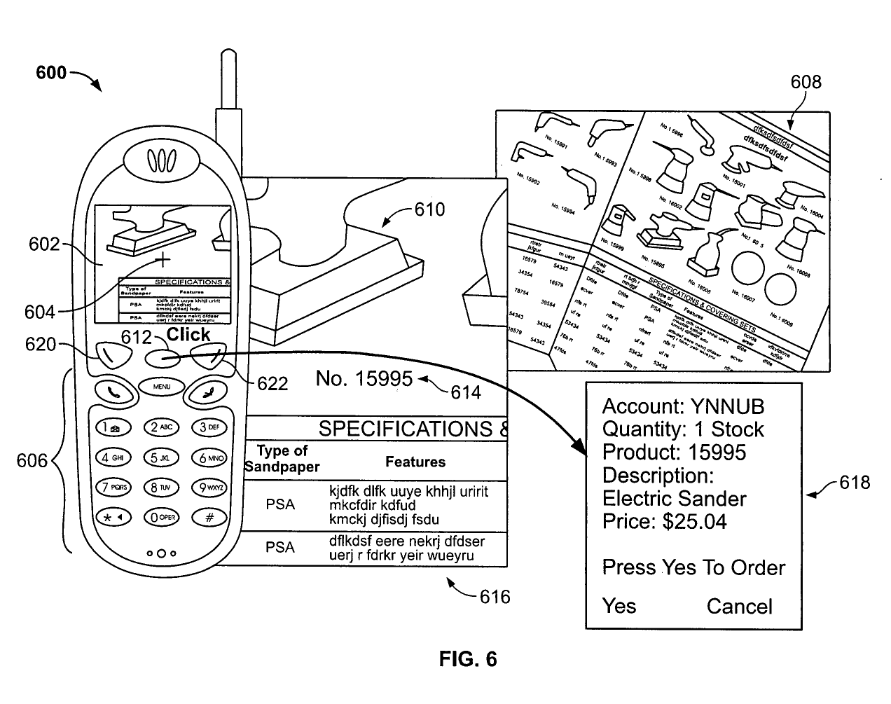

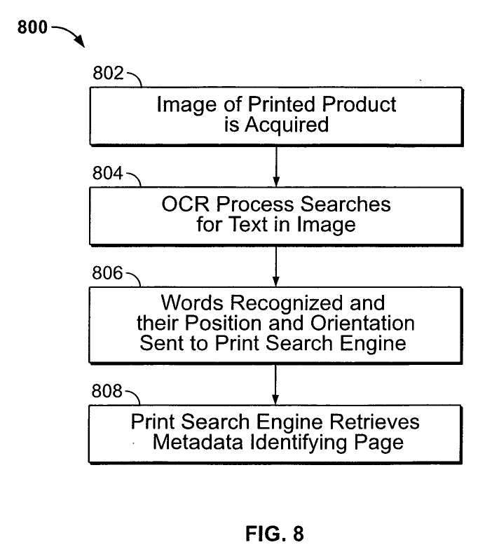

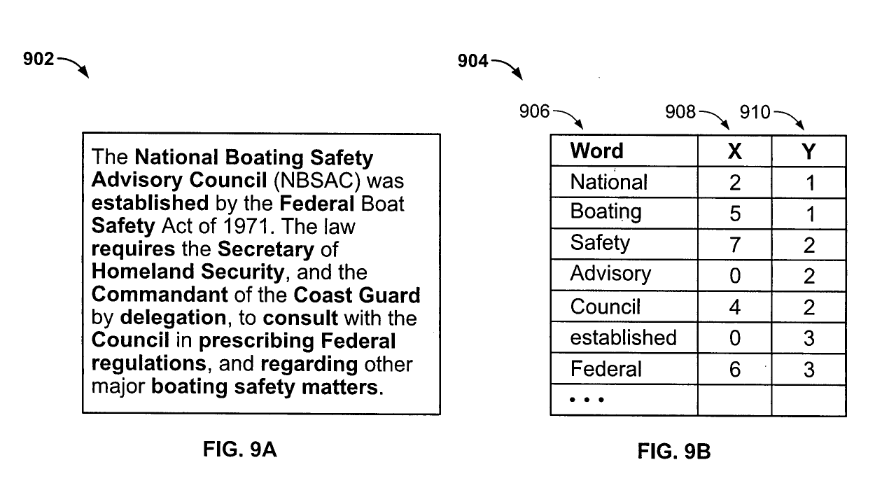

The “Print-Link” service, which may operate on a platform having one or more of the features of server 22 and databases 18 and 20 (shown in FIG. 1), may include a server, a search service, and a database of printed items. The “Print-Link” service performs optical character recognition (“OCR”) on the image (step 508), and recognizes text in the image. In some embodiments, the “Print-Link” service may perform shape recognition on the image. The “Print-Link” service selects significant text from the text recognized in the image, as described in further detail below, with respect to FIG. 8 and FIG. 9. The “Print-Link” service uses the selected text to search one or more databases for an archived electronic copy of the item imaged by the camera phone (step 510) and identifies and retrieves the electronic copy (step 512). The “Print-Link” service determines the coordinates in the archived electronic copy corresponding to the position of the cross-hairs when the cross-hairs are overlaying a targeted portion of the physical copy (step 514). The coordinates of the cross-hairs are used to determine the specific location in the imaged portion of the physical text selected by the user. In one embodiment, the user pushes the “Print-Link” button on the phone, as shown in FIG. 6, to “click” on the point corresponding to the location of the cross-hairs. In some embodiments of the invention, the location, for example the center coordinates, of the imaged portion corresponding to the placement of the cross-hairs is mapped to a URL. According to one example, the printed item includes a “Click Here” area where the cross-hairs should be positioned before pushing the “Print-Link” button. When a user pushes the “Print-Link” button, the service looks up the URL mapped to the location of the cross-hairs in the imaged portion of the printed item (step 516). The “Print-Link” service returns the specified URL to a web browser in the camera phone (step 518).

When the URL is displayed in the display of the camera phone, the user may perform a desired function associated with the printed item (step 520). In some embodiments of the invention, the URL may be a web page for purchasing an item selected using the cross-hairs of the display as described above, and as shown below with respect to FIG. 6, and the user may use the web page to purchase the selected item. According to another embodiment, the user may view a web page, for example an informational web page corresponding to a link in the printed item selected by the user using the “Print-Link” service, or may click on a link to another web page. These functions are described in greater detail below, with respect to FIGS. 6, 12, 13A, and 13B.

In some embodiments, the user may focus the cross-hairs of the display on a coupon, which can then be redeemed when the user presses the “Print-Link” button. Funds or credit may be transferred to an account held by the user or an electronic certificate may be stored, for example in the camera phone, for later exchange between the user and another party. In one example, after the user has selected a product to purchase from a vendor, a web page displayed on the camera phone may include an option for a user to redeem a coupon for the product before final purchase.

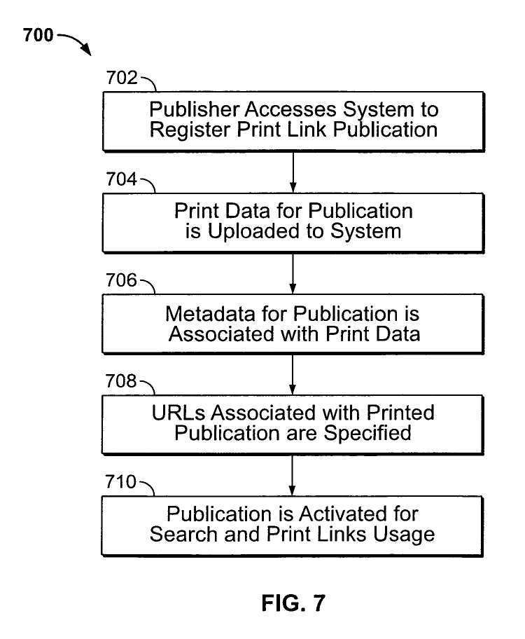

In some embodiments of the invention, the user may focus the cross-hairs of the display on an advertisement for a movie or theater show. When the user pushes the “Print-Link” button, the image taken by the camera is sent to a “Print-Link” service, which performs OCR on text within the image to recognize the advertisement, and identify the corresponding electronic version of the advertisement. Once the electronic version has been identified, the “Print-Link” service sends the associated URL to the user device, which may be a web page for purchasing tickets to the movie or show. The movie or theater show advertisement, and the associated URL, may have been previously registered with a “Print-Link” service, as described in further detail below, with respect to FIG. 7.

In some embodiments of the invention, the Print-Link service may be realized as a software component operating on a WCD such as WCD 200 or on any conventional data processing system. In such embodiments, the Print-Link system can be implemented as a C language computer program, or a computer program written in any high level language including C++, Fortran, Java or Basic. In some embodiments of the invention, WCD 200 may include microcontrollers or DSP's. In those embodiments, the Print-Link service can be realized as a computer program written in microcode or written in a high level language and compiled down to microcode for execution on the platform employed.

The development of imaging systems such as those described in connection with WCD 200 is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing (1983). It is noted that DSP's are particularly suited for implementing signal processing functions, including preprocessing functions such as image enhancement through adjustments in contrast, edge definition and brightness. Developing code for the DSP and microcontroller systems follows from principles well known in the art.

FIG. 6 shows an illustrative implementation of method 500 (shown in FIG. 5) using illustrative camera phone 600. In the example, camera phone 600 is used to order item 610 from catalog 608. Camera phone 600 includes display 602 with cross-hairs 604, and keypad 606, including “Print-Link” button 612. Camera phone 600 may be any suitable mobile telephone including a camera or other imaging device. In some embodiments of the invention, a user may use camera phone 600 to take picture 616 of item representation 610 (the item itself being a tool, in this example), or of a link associated with the item, from a catalog. In some embodiments of the invention, cross-hairs 604 of display 602 are positioned over a portion of catalog 608 that uniquely identifies the item (the tool, in this example) that the user would like to purchase.

For example, cross-hairs 604 may be positioned over item number 614 (“No. 15995”). When the cross-hairs 604 on display 602 of the camera are in the desired position, the user pushes “Print-Link” button 612. In some embodiments, this may activate “Print-Link” software, which sends the picture 616 to a server. The “Print-Link” software may also send information to the server that uniquely identifies the user. The server returns associated web page 618 to camera phone 600, which may provide the user with an opportunity, via the web page 618 displayed on the display 602 to purchase the item that corresponds to item representation 610 (the tool). In some embodiments of the invention, if the user decides to purchase the item, the user selects “YES” on the display by pushing button 620, while if the user decides not to purchase the item, the user selects “CANCEL” on the display 602 by pushing button 622. In some embodiments of the invention, the URL may lead the user to other options, for example, the user may be able to select a link to view more information about an item shown in catalog 608

FIG. 7 shows a flow chart of illustrative method 700 for storing an electronic copy of a physical document, and associated URL's corresponding to features of the document, in a Print-Link system server. For the purpose of this illustration, the physical document will be referred to as a “Print-Link” publication. A printed item provider, such as a publisher, may access a Print-Link system to register a Print-Link publication (step 702). The Print-Link system may include a server, such as server 22 of FIG. 1, and a database of publications, such as database 18 of FIG. 1. The Print-Link publication may be any suitable publication. The publisher uploads print data corresponding to the publication to the Print-Link system (step 704). The print data may be the data used to print a physical copy of the publication, or it may be any suitable electronic copy of the publication. Additionally, any metadata for publication may be associated with the print data uploaded to the Print-Link system (step 706). The publisher may also specify URL's associated with the physical document, which may be a printed publication (step 708). In some embodiments of the invention, one or more locations within the publication may be associated with one or more URL's. Associating URLs with parts of a page is done in the same way as areas in images on web pages are mapped to URLs. Those skilled in the art will understand the techniques for such mapping. In some embodiments of the invention, the publisher may not specify the URL's associated with the physical document, and the Print-Link system or other service may instead specify the URL's associated with a selected printed publication. In some embodiments of the invention, different URL's may be returned for different query sources. For example, the returned URL's for a cell phone, a PDA and another portable computer system may all be different. In another example, the URL returned may depend on the geographical location of the query, such as for the purchase of movie or theater tickets. The publisher can also specify the types of access that is allowed to the electronic version of the publication. For instance, it may be that the publication is only used for searching and then mapping the searches to a URL. In other cases, the electronic version of the document may allow for searching and also be used for display. Furthermore, the publisher may block any part of a page from searching or display. Such blocking may be necessary to protect the copyright holders for the specific information being blocked.

According to one embodiment, the print data uploaded is stored in a database of publications, such as database 18 of FIG. 1, in its original format, preferably PDF or another format that does not require OCR to find all the text in the publication. After the print data is uploaded, the publication may be scanned to find all words and their locations on the page. This data may also be stored in a database such as database 18 of FIG. 1, or it may be stored in a database separate from the uploaded publication. The database of words and associated word locations may be used for finding pages given a set of words or a set of words and their associated locations in a query. The set of words and associated locations in the page may be used later to identify a page and the specific location on the page for the query. The location information may be stored using any suitable units, and the unit system may not need to be predetermined within the database, provided that the units are saved with the location coordinates.

Once the print data is uploaded, the Print-Link service activates the publication for search and usage within the Print-Links system (step 710). The Print-Link system may include all uploaded print data and the associated publications in a searchable database. According to one embodiment, if an image centered on a specific location within a publication is sent to the Print-Link system, the system will identify the image source publication and return to the sender the associated URL specified.

The location on the page may be calculated using the location coordinates of at least two words on the page in the database and the location coordinates in the image space of same two words in the image acquired by the Print-Link device. This information enables the generation of a transformation matrix that can map any coordinate from the acquired image into a coordinate of the page in the database. The coordinates of the selected location on the page in the database may then map to a URL that may have been specified by the publication provider for that page. Those skilled in the art understand the methods used to generate transformation matrices and the use of transformation matrices for translating from one coordinate space to another.

Page Recognition

FIG. 8 is a flow chart of a method 800 for uniquely identifying a printed page given an image of a portion of the page in accordance with the principles of the invention. The method begins with acquiring an image of a printed item (step 802). The image may contain only a portion of a page of a printed item. According to one embodiment, the image contains text. An OCR process searches the image for text (step 804). Also, certain errors and/or noise within the acquired image may be reduced or eliminated during the OCR process. The OCR process identifies text and recognizes words in the text. Further, the words may be filtered through a dictionary to ensure that words submitted for recognition are valid words for a selected language. Words that are not recognized correctly may be rejected if not found in the dictionary.

According to one embodiment, the acquired image is filtered to reduce or eliminate noise, and/or to de-speckle the image. Noise filters are well known in the art, and any such filter may be used. According to one embodiment, the filter includes a density function, which calculates the size of selected marks or spots on a page. One example of such a density function is described in U.S. Pat. No. 5,659,638, which is hereby incorporated by reference in its entirety. Another filter may be use to select the size of the marks or spots to remove from the image. According to one example, marks that have a width less than a certain number of pixels and/or a height that is less than a certain number of pixels may be removed from the image. Additionally, the acquired image may include long lines or other stray marks, for example from printing or copying the image. Thus, the filter may include settings to remove large marks or lines. This may be especially useful for reducing noise around the text of a printed item.

OCR is a method for translating images of typewritten text into machine-editable text, or to translate pictures of characters into a standard encoding scheme representing them in (ASCII or Unicode). This allows for machine-reading of typeset, typed, and, in some cases, hand-printed letters, numbers, and symbols using optical sensing and a computer. According to some embodiments, the light reflected by a printed text, for example, is recorded as patterns of light and dark areas by an array of photoelectric cells in an optical scanner. A computer program analyzes the patterns and identifies the characters they represent, with some tolerance for less than perfect and uniform text. OCR is also used to produce text files from computer files that contain images of alphanumeric characters, such as those produced by fax transmissions.

The position and orientation of the recognized words is sent to a print search engine (step 806). According to one embodiment, only words considered to be significant are sent to the search engine. According to a further embodiment, only a small number of significant words are sent to the search engine, since only a few words are necessary to identify the text. According to various embodiments, about 2, about 3, about 5, about 7, about 10, about 15, about 20, about 25, about 35, or about 50 significant words are used to identify the document.

According to various embodiments, there are different methods of determining word significance. In one embodiment, a dictionary including word frequency may be consulted. Word frequency may be the frequency a selected word occurs in the printed items of a database. The process may include a selected word frequency level, wherein any identified words with a frequency equal to or higher than the selected level are not considered significant, and any identified words with a frequency lower than the selected level are considered significant. For example, conjunctions, prepositions, and articles such as “and”, “to” and “a” may have a high frequency, and may not be considered significant. According to one embodiment, the high-frequency, non-significant words are known as “stop words.”

In another embodiment, significance or confidence score may be defined by analyzing the letter frequency within a word aggregated to a word level. For example, if the word ‘quiz’ would have more significance than the word ‘this’ since the letters q, u and z are less frequently used in the English language than t, h and s. Different frequency dictionaries are required for each language when this method is used.

In a further embodiment, word length may be used to determine significance. According to this embodiment, a word with a length equal to or greater than a predetermined value or threshold is considered significant, while a word with a length less than the predetermined value is not considered significant. In one example, words reaching a threshold of seven or more letters are considered significant. In other examples, words with at least about 4, at least about 5, at least about 6, at least about 8, and at least about 10 letters are considered significant. In another embodiment, words are ordered by length and the longest words up to a predefined count are considered significant and used for recognition. Those skilled in the art of text searching, such as searching websites for specific words, understand the various methods that may be used to filter searches by word significance. Such filtering may reduce search times and may also reduce the number of items in the resulting set of matched items.

There are several different ways in which the significant words may be sent to the search engine. In one embodiment, a set of unordered words is sent to the search engine, and enough words should be sent such that those significant words in any order on a page can uniquely identify the imaged page. In order to identify a unique page in the database, a plurality of words may be sent to a search engine, and the search engine may filter the words and calculate the significance of the words. According to one embodiment, all recognized words are sent to the search engine. According to an alternative embodiment, a subset of the words on the imaged page is sent to the search engine. According to one embodiment, the number of words needed to uniquely identify the printed item depends on the significance of the selected words. In various examples, the imaged page may be identified by the search engine with about 6, about 7, about 8, about 10, or about 12 or more significant words.

In another embodiment, a set of ordered words is sent to the search engine. The selected words appear in the imaged page in a particular order, and an identified document contains the selected words in the same order. The words on the page may be ordered from first to last, last to first, left to right, right to left, or any other suitable order specified to the search engine. The selected words may be from different locations in the image, but their order is maintained. According to one embodiment, the number of words needed to uniquely identify the printed item depends on the significance of the selected words, and fewer ordered words may be needed to identify the document than would be necessary if the words were unordered. In various examples, the imaged page may be identified by the search engine with about 3, about 4, about 5, about 6, or about 7 or more ordered significant words.

In a further embodiment, a set of words and the coordinates of their respective locations or their word-level topological properties within the image are sent to the search engine. The set of words and their coordinates or topological properties may be representative of a signature corresponding to the scanned image including the words. The coordinates may represent the location of each word on the page, the location of each word in the imaged portion of the page, or the relative locations of the selected words. In one embodiment, the coordinates of the beginning of the word and the coordinates of the end of the word can be used to determine word width. In another embodiment, the coordinates of the beginning of the word can be used in combination with OCR to determine word width. According to one embodiment, the number of words needed to uniquely identify the printed item depends on the significance of the selected words, and fewer words with location coordinates may be needed to identify the document than would be necessary if the words were sent without coordinates. In various examples, the imaged page may be identified by the search engine with about 2, about 3, about 4, about 5, or about 6 or more significant words and their respective location coordinates.

After the selected words and associated information are sent to the search engine, the search engine identifies the associated printed item and retrieves the metadata identifying the imaged page (step 808).

FIGS. 9A-9B depict an example the information input to a printed item identification process which uses the significant words and the coordinates of the location of the words in an image, in accordance with the principles of the invention. FIG. 9A shows an electronic text version 902 of an imaged document. The electronic text version may have been created using OCR from an image input by a user. Selected significant words in the electronic text version are shown in bold. FIG. 9B shows an exemplary table 904 listing the first nine bolded words 906 along with their X (908) and Y (910) coordinates. The X (908) and Y (910) coordinates may describe the positions of the words in the electronic text version 902, or they may describe the positions of the words in the original image. Additionally, the X (908) and Y (910) coordinates may represent the relative positions of the words on the page. The X (908) and Y (910) coordinates may represent Cartesian coordinates.

Virtual Library

Some embodiments of the invention may include a virtual library that enables one or more users to retrieve one or more electronic documents to which the user has access to a physical counterpart. In some embodiments, the counterpart may be printed matter such as, without limitation, a book, manual, magazine, digest, newspaper, pamphlet, poster, billboard, advertisement, poster, label, and like visually perceptible images or media.

Server 16 (shown in FIG. 1) may interface with and/or support the storage of electronic documents in one or more databases such as database 18, database 20, database 24, and any other database accessible to server 16. Server 16 may provide each user with access to one or more electronic documents located in the various servers 18, 20, and 24, essentially providing a virtual library to each user. In some embodiments, all of the electronic documents associated with the virtual library of a particular user may be stored within a particular database such as database 18.

Server 16 may include an access control application such as 408 (shown in FIG. 4) that enables server 16 to restrict access to one or more electronic documents, or restrict access to a particular user's virtual library based on the user's identity information or other access control rules. The access control rules may limit a user's access to certain documents based on criteria such as limiting the amount of content that a user can access over a period of time, limiting access to a portion of the available content over a period of time, limiting the amount of content based on the user's identity, and/or limiting access based on certain information associated with the content. Other criteria may be applied such as the location from which a request is made, the date or time when the request is made, the number of requests made over a period of time, and the number of requests made for a particular document or type of document over a period of time.

In some embodiments of the invention, server 16 may restrict access to a particular electronic document based on whether the user provides proof of ownership, possession, or authorization to access the electronic document.

Proof of possession may include requiring that the user provide to the server a representative image of the physical counterpart. The representative image may include a picture and/or captured image of a portion of a page of the document. The representative image may also include, for example, a paragraph within a page of a document, a single sentence, a group of words, a document identifier or serial number, a figure, a picture, and/or combination of the foregoing. The proof of possession, ownership, or authorization to access may also include: 1) properly responding to a set of queries from a document provider via server 16 associated with a requested electronic document, 2) presenting a serial number on a printed item, 3) transmitting to the server a serial number and/or response from a radio frequency identifier (RFID) or other electronic tag, and/or 4) presenting a proof of purchase associated with purchase of electronic document or the physical counterpart. Server 16 may periodically require that each user provide proof of possession of, ownership of, or authorized access to the physical counterpart before providing to the user permission to view one or more electronic documents. For example, a user may be required to prove possession of the physical counterpart upon each access or on a daily, weekly, monthly, semi-annual or annual basis.

An electronic documents may include a scanned image, electronic text, text data file, figure, and/or electronic objects suitable for embedding within an electronic document, and/or HTML, XML, WML, and like hypertext mark-up generated images. The electronic text may be in the form of text within a text file and/or editor-based file such as WordPerfect, Microsoft® Word and Latex. The text file may include characters in an ASCII-based encoding, an EBCDIC-based encoding, including embedded information such as font information, hyperlinks or inline images. The text file may include text encoded in an extension of ASCII such as, without limitation, ISO 8859, EUC, a special encoding for Windows, a special Mac-Roman encoding for Mac OS, and Unicode encoding schemes such as UTF-8 or UTF-16. A text data file may be use to generate a grayscale image of the originally scanned file.

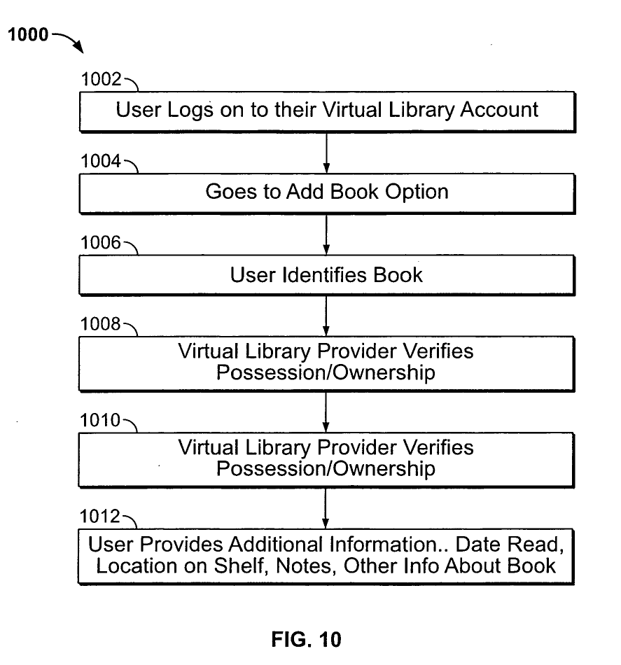

FIG. 10 shows a flow diagram of an exemplary registration process in which a user adds an electronic document to the user's virtual library. First, the user logs onto the user's virtual library account (step 1002). The virtual library account may be located and/or managed by server 16 (shown in FIG. 1). The logon process may include providing at least a user identifier to server 16 which may be verified by an access control application such as 408 (shown in FIG. 4). The user identification information may include a user name, a login name, an email address, a phone number, or any suitable identification information. According to one embodiment, in which the user accesses the virtual library through a cell phone, the server 16 may automatically identify the user by caller ID of the user telephone number. In addition to identification information, the user may be required to provide some type of authentication information associated along with the user's identification such as, without limitation, a password, secret, biometric, token, and like authentication and/or authorization information to obtain access to their virtual library. The user may interface with server 16 via web server 404 (shown in FIG. 4) and a user client 12 web browser. In this embodiment, the web server 404 provides an interface to enable user interaction with the web server 404 of server 16 to effect control of the virtual library associated with the particular user.

Once access is obtained, the user initiates an Add Book Option to add a new electronic document to the user's virtual library (step 1004). The Add Book Option may be initiated by clicking on an icon or action button within a web page presented by the web server 404 of server 16. Other interface applications and features may enable the user to initiate the Option. Once the Add Book Option is initiated, the user may be presented with a list and or textual search menu to identify, or confirm the identity of, the electronic document corresponding to the physical counterpart. In connection with some embodiments, the user may scan a portion of the physical counterpart, such as a serial number or a portion of text, and submit the portion to server 16 via client 12. Server 16, may then convert the received portion into electronic text and/or graphics using an OCR-based conversion process. Using the converted portion, server 16 may then search for and identify the electronic document. According to this embodiment, the user identifies the particular electronic document desired for inclusion in the user's virtual library (step 1006).

Server 16, which may be operated by a virtual library provider, then verifies that the user owns, possesses, and/or is authorized to access the requested electronic document (step 1008). The verification may include requiring the user to provide: an image of a portion of the physical document in the user's possession, responses to one or more queries, a serial number associated with the physical document in the user's possession or product associated with the document, an identifier from an RFID, electronic tag, smart card, and/or like identification token, and/or a proof of purchase of the possession of the physical document associated with the requested electronic version of the document.

The access control application (such as Access Control 408, shown in FIG. 4) of server 16 (shown in FIG. 1) verifies that the information provided by the user is correct by comparing user provided information with verification information stored within, for example, a user account database. The user account database may be included, for example, in database 20 (shown in FIG. 1).

In some embodiments of the invention, access control application 408 verifies possession of ownership by comparing a scanned image of the physical counterpart with an image of the document accessible to the access control application 408. In some embodiments, server 16 may employ OCR application 400 (shown in FIG. 4) to convert the scanned image into an electronic version of the physical counterpart. At least a portion of the scanned image may include electronic text and/or text and graphical objects. Access control application 408 then compares one or more features and/or characteristics of the OCR-recognized words and/or text with the text of a stored version of the document to determine whether the user is in possession of the physical counterpart.

Once possession is verified by the access control application 408, the user may provide additional information and/or metadata that can be associated with the electronic document that has now been added to the user's virtual library (step 1012). The metadata may include, without limitation, date read, location of physical copy, user notes regarding the subject of the document, and any other information that the user considers relevant to the document (step 1012).

According to one embodiment, other options may be performed within the user's virtual library, including but not limited to, removing books from the library, grouping or ungrouping books within a virtual library, moving books from one grouping to another, placing books into multiple groups in a virtual library.

In some embodiments of the invention, server 16 provides user access to electronic images of physical text based on the user's proof of ownership of the physical text. In this instance, server 16 receives a request for access to one or more electronic images associated with physical text of a physical document. In one embodiment, the request identifies the user submitting the request. Upon receipt of the request, server 16 confirms user ownership of the physical document and/or text based on the user identity. Server 16, using the access control application 408, may consult one or more access rules that define an amount of content in electronic images of the physical text that can be provided to the user based on the user's ownership of the physical text. In one embodiment, the defined amount of content for users who own the physical document and/or text is greater than the amount of content that may otherwise be provided to a user who does not own the physical text. The server then provides user access to the one or more electronic images of the physical document based on the one or more access rules.

In another embodiment, server 16 provides access to a virtual library of electronic content that is personalized for at least one user. Server 16 may automatically include electronic images of the physical text in the user's virtual library for later access. Instead of actually retrieving certain electronic document information, server 16 may store a link in the user's virtual library. By accessing the link, the user is provided access to the images in a centralized database 18 of images or a distribution of multiple databases 18, 20, and 24 of images.

Access control application 408 may include an indicator associated with each image in the user's virtual library to indicate that user ownership of the physical text has been confirmed. When confirming user ownership of a particular electronic document and/or image, access control application 408 may review purchase information pertaining to the user to determine whether the user has purchased the physical document and/or text associated with the stored electronic version.

In some embodiments of the invention, the server communicates with a third party regarding purchase information of the user. For example, the third party may be a registry providing ownership information of a particular document, a retailer and/or seller of the physical document, a manufacturer of a product associated with the document, and any entity with information regarding ownership of the physical document. Server 16 may confirm ownership by receiving from the user a receipt evidencing purchase of the physical document. Server 16 may confirm ownership by receiving from the user an image of a page from the physical text.

In some embodiments of the invention, access control application 408 includes one or more access rules to permit user access to electronic images of the entire physical document. The user's ownership of the physical text may result from the user's purchase of an item that the physical text normally accompanies. For example, the user may purchase a stereo that includes an operations manual.

The electronic version of the document may include a scanned image, electronic text, text data file, figures, and/or objects within an electronic document, and/or HTML, XML, WML, and like hypertext mark-up generated images. The electronic text may be in the form of text within a text file and/or editor-based file such a WordPerfect, Microsoft® Word, and Latex. The text file may include characters in an ASCII-based encoding, an EBCDIC-based encoding, including embedded information such as font information, hyperlinks or inline images. The text file may include text encoded in an extension of ASCII such as, without limitation, ISO 8859, EUC, a special encoding for Windows, a special Mac-Roman encoding for Mac OS, and Unicode encoding schemes such as UTF-8 or UTF-16. A text data file may be use to generate a grayscale image of the originally scanned file.

Page Windowing

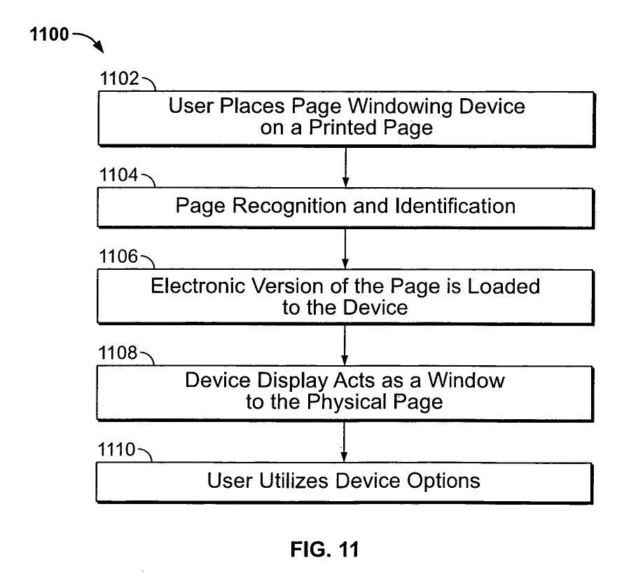

FIG. 11 shows a flow chart of illustrative method 1100 for displaying an electronically captured image of a printed item, which for the purposes of illustration will be represented by a printed page that includes text. Method 1100 may utilize a page windowing device such as WCD 200 (described above and shown in FIGS. 2 and 3), which may include one or more of an internet connection, an internet browser, a page-windowing application, a page renderer, a touch screen or button interface, a page tracking system, a display and a page scanning system. The page tracking system may be a mouse-like movement tracking system such that the device may be moved about the page in the same manner in which a mouse is moved about on a computer mouse pad. The page scanning system may be a camera, or it may be a scanner, such as a line scanner, which captures the text on the page. The page tracking system and the page scanning system may also be the same system.

Method 1100 begins as a user places the page windowing device on the printed item, such as the printed page referred to in step 1102. The page scanning system may capture an image of the page as it is initially placed on the page and/or after it is placed on the page. The page scanning system may continuously update the captured image, such that the image represents the portion of the page most recently positioned underneath the device. The page scanning system may provide the captured image to the display for presentation to the user. The captured image may be displayed and continuously refreshed such that it remains registered with the printed page in the scanning system field of view.

The page-windowing application on the device may send the most recently captured image to a server which performs OCR on the image, and identifies printed page (step 1104). The server may identify the printed page using systems and methods described herein. An electronic version of the printed page may be loaded into the page renderer (step 1106) to present the electronic version to the user. In some embodiments of the invention, the electronic version may be registered to the underlying physical page, thereby allowing the display of the device to act as a “window” through to the physical page (step 1108). In those embodiments, as the device is moved or rotated with respect to the physical page, the electronic version remains spatially registered with the printed page.

The electronic version, as displayed on the device screen may have several capabilities which the user may choose to utilize (step 1110). The capabilities may include, for example, one or more of the capabilities described herein with respect to client 12. The electronic version may have active links, which may be specified by a party that owns or holds rights in the printed page, which may be the printed page publisher. The links may include hyperlinks to associated web pages. The links may include hyperlinks to on or more sources that are independent of the printed page. For instance, a student textbook may have a link that returns more detail on how to solve a particular problem. A weekly magazine may have a link that returns details not included in the article.

The electronic version may include buttons that effect a change in the content of the page. For example, a page with today's weather forecast may include a button which, when activated, causes the display to show tomorrow's forecast. In another example, a graph showing a 3 month stock trend s may include a button, which when activated, shows an annual trend. In some embodiments of the invention, the electronic version may include a display of moving graphics. For example, if the device were placed over a catalog item showing a pair of shoes, the display may show a changing image showing the shoes from multiple viewpoints.

The electronic version of the page may also include a feature generally known as “Tool Tips,” which shows what a particular button or item on the screen is by popping up a window defining the function of the button or a definition of the item. In some embodiments, the electronic version of the page may be used to display word definitions of selected words simply by letting the device hover over the word. Some of those embodiments may include a device operating mode in which a word definition is displayed without requiring receipt of a user indication to display the definition. For example, client 12 may be configured to identify a word under a cross-hair and display the definition without further action on the part of the user. In some those embodiments, client 12 may be configured to identify the word, obtain a translation into a different language, which may be user-selected, and display the translation to the user.

Additionally, the electronic version could include audio clips, such that a publisher could define a selected audio clip for a given page or link. In one example, a user may use the device to capture an image of a weather forecast, and an associated forecast recording may be played on the device. In another example, a user may use the device to image a box of cereal, and an associated audio track, such as a jingle, saying, or phrase from a television commercial, may be played on the device. For example, if the device were placed over a portion of a breakfast cereal box showing a dancing bear, the display may show an animated dancing bear and, in embodiments in which client 12 has audio speakers, client 12 may play an audio file alone or in conjunction with the animation.

According to various embodiments, while some links may provide content that works best with the device laid over the page, other links may bring the user to an internet site or other source that is independent of the page.

In some embodiments of the invention, the page-windowing device may include a tracking system similar to a mouse that detects movement and rotation, as described above. The system could use a complementary metal oxide semiconductor (CMOS) image sensor to determine the device's location on the printed page. The CMOS sensor is a camera-like sensor and it may image small 2-dimensional areas while it moves across the page. In some embodiments, the device may include one or more accelerometers placed in or along one or more planes to detect and measure movement of the device. The accelerometers may assist in “moving” the electronic version of the page, relative to the display, to maintain in the display an electronic version that is registered to the printed page below the display. Accelerometer-based dynamic registration may provide registration even with respect to regions of the printed item that do not include text.

According to one embodiment, because the display window is synchronized with the underlying printed product, the page-windowing device may be rotated on the page, and the image displayed on the display window, would similarly rotate effectively keeping its position and orientation synchronized with the physical page.

In some embodiments of the invention, the page-windowing device may be used when the device is held at a distance from the printed item. The device may be located off the page, and a standard device camera may be used for imaging. The only limitation on maximum distance between the device and the printed item may be the focusing depth of the camera. Ideally, the device is close enough to the printed item for the image produced by the camera to OCR-recognizable text. The device may include a lighting system for illuminating the area being imaged.

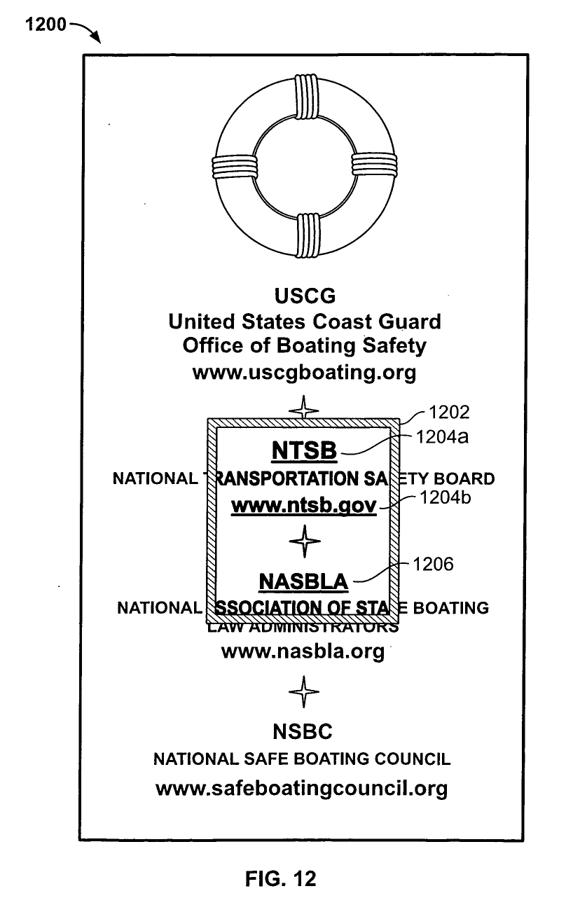

FIG. 12 shows illustrative printed page 1200 and window 1202 displaying an electronic version 1201 of a portion of page 1200. In window 1202, links 1204a, 1204b, and 1206, which have been added to electronic version 1201, are underlined.

In some embodiments of the invention, the user may click on one of the links 1204a, 1204b, or 1206 and be directed to an associated web page. The user may click on these links using the cross-hairs of the display and the “Print-Link” button described above with respect to FIGS. 5 and 6, or the display may be a touch screen, allowing the user to select a link using a finger or stylus. Any text, picture, icon, or other feature of printed item 1200 may have an associated link. The links may not be limited to web page addresses. In some embodiments of the invention, an active link indicator may be provided to identify “hidden” links in electronic version 1201 that are often associated with non-text objects. The active link indicator may be present in window 1202 and may provide a visual cue, such as a shape, size or color change when the indicator is moved adjacent a feature on page 1200 that corresponds to such an object in electronic version 1201.

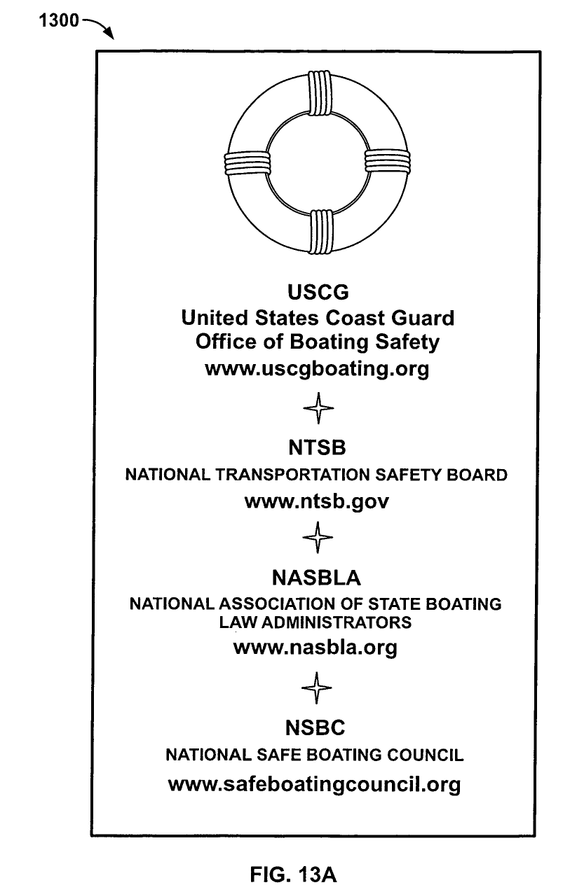

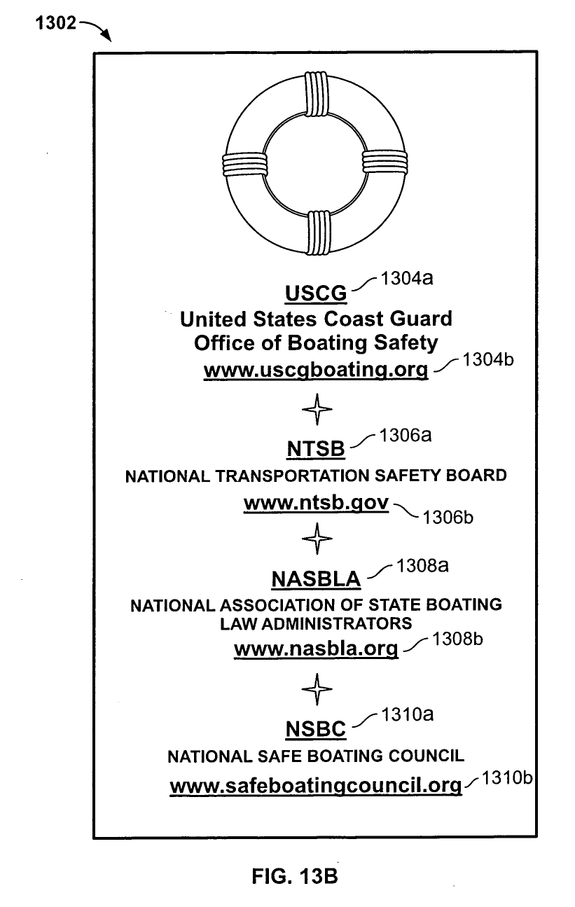

FIGS. 13A and 13B show illustrative printed item 1300 and electronic version 1302 of the printed item, respectively. As shown in FIG. 13B, electronic version 1302 includes links 1304a-1304b, 1306a-1306b, 1308a-1308b, and 13101-1310b. Links 1304a and 1304b may link to a web page address, as may links 1306a and 1306b, links 1308a and 1308b, and links 1310a and 1310b. A user may use the page-windowing device to select the “USCG” link 1304a and connect to an associated website.

According to various embodiments, a user may use the page-windowing device to connect to multimedia links. For example, a camera link may connect a user to streaming video, a photo link may connect a user with a set of photos, a video link may connect a user with a pre-recorded video clip, and an audio link may connect a user with an audio clip.

It will be apparent to those of ordinary skill in the art that methods involved in the present invention may be embodied in a computer program product that includes a computer usable and/or readable medium. For example, such a computer usable medium may consist of a read only memory device, such as a CD ROM disk or conventional ROM devices, or a random access memory, such as a hard drive device, memory chip, or a computer diskette, having a computer readable program code stored thereon.

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

I claim:

1. A method for providing information associated with an acquired image, the method comprising:
acquiring an image from a printed item, the printed item associated with a virtual rendition of the printed item stored in a database,
identifying the virtual rendition based on at least a portion of the acquired image,
selecting a feature in the acquired image, and
providing the information based on the feature.

2. The method of claim 1 wherein the image includes text.

3. The method of claim 1 wherein the image includes a logo.

4. The method of claim 1 wherein the image includes a picture of an object having a characteristic shape or color.

5. The method of claim 1 wherein the printed item is part of a catalog.

6. The method of claim 1 wherein the virtual rendition comprises a copy of the printed item.

7. The method of claim 1 wherein the virtual rendition comprises a map of elements on the printed item.

8. The method of claim 1 wherein selecting comprises receiving a user indication of the feature.

9. The method of claim 1 wherein selecting comprises placing a crosshair on the feature.

10. The method of claim 1 wherein the provided information includes a description of an object associated with the characteristic feature, an order form for the object, a URL to a page or portion of a page containing a representation of the object, a link to a specification or other information associated with the object, or a combination thereof.

11. The method of claim 1 wherein identifying the virtual rendition includes transmitting the acquired image to the database and matching at least the portion of the acquired image to at least one image attribute of the virtual rendition.

12. The method of claim 11 wherein the acquired image is transmitted to the database via a local area network, a wide-area network, or the Internet, or a combination thereof.

13. The method of claim 11 wherein acquiring the image acquisition device comprises capturing the image using a cell phone camera.

14. A system for providing information associated with an acquired image, the system comprising:
an image acquisition device configured to acquire an image from a printed item, the image acquisition device further configured to allow a user to select a feature in the acquired image,
a database that stores a virtual rendition of the image from the printed item, and
a processor identifying the virtual rendition based on at least a portion of the acquired image.

15. A method of identifying a printed item based on textual information acquired from a printed item, comprising:
identifying in the textual information at least one word,
comparing a significance of the at least one identified word with textual information of documents stored in a database and containing a virtual rendition of the printed item, and
identifying a document that contains the printed item based on the comparison.

16. The method of claim 15, wherein comparing the significance includes determining an organization of the identified words on the printed item.

17. The method of claim 15, wherein comparing the significance includes determining a frequency of the at least one identified word, and comparing the frequency of the at least one identified word in the area of the printed item with a frequency of the at least one identified word in a reference text.

18. The method of claim 15, wherein comparing the significance includes determining a spatial relationship between a plurality of identified words.

19. The method of claim 18, wherein determining the spatial relationship includes determining an order of the plurality of identified words in the area of the printed item.

20. The method of claim 15, wherein determining the spatial relationship includes determining coordinates of the at least one identified word in the area of the printed item.

21. The method of claim 15, wherein identifying the document includes retrieving metadata identifying the document.

22. A system for identifying a printed item based on textual information on the printed item, comprising:
a database storing electronic renditions of printed items,
an image acquisition device acquiring an image of the printed item, and
a processor receiving the acquired image and identifying textual information in the acquired image,
wherein the processor determines an attribute of a word in the identified textual information and compares the determined attribute with an attribute associated with an electronic rendition of a printed item stored in the database, and identifies an electronic rendition of the printed item in the database.

23. A method for controlling user access to an electronic library of printed documents, comprising:
receiving a user registration;
receiving information that identifies a physical document;
determining, based on the received information and the user registration, whether a user has rights to access an electronic document corresponding to the physical document;
if the user has rights, identifying, based on the received information, the electronic document in the electronic library that corresponds to the physical document; and
providing to the user access to a copy of the electronic document.

24. The method of claim 23, wherein the information that identifies a physical document comprises an image of at least a portion of the physical document.

25. The method of claim 24, wherein the image comprises text.

26. The method of claim 23, wherein the information that identifies a physical document comprises a serial number associated with the document, a barcode, a UPC code, an electronic tag, a proof of purchase, a user-supplied answer to a query from the electronic library relating to the physical document, or a combination thereof.

27. The method of claim 24, wherein the information comprises topological attributes of printed objects in the image.

28. The method of claim 25, wherein identifying includes converting text into alphanumeric characters by optical character recognition and comparing the converted text with text in the electronic document.

29. The method of claim 23, comprising after the receiving, issuing to the user a request to provide information that identifies the physical document.

30. The method of claim 23, wherein the physical document is a printed document selected from the group consisting of a book, a magazine, a journal, a newspaper, a manual, a reference, and an article.

31. The method of claim 24, wherein the image is produced by a scanner, a digital camera, or a camera of a mobile communication device, or a combination thereof.

32. The method of claim 23, wherein the electronic copy of the document is searchable.

33. The method of claim 23, further comprising creating a personal electronic library for the user.

34. The method of claim 33, further comprising storing in the personal electronic library a pointer to the authorized copy or an electronic version of another user-owned document.

35. The method of claim 33, further comprising providing the registered user an opportunity for allowing another user to access at least a portion of the personal electronic library of the registered user.

36. A system for controlling user access to an electronic library of printed documents, comprising:
a database storing an electronic copy of a physical document, and
a server receiving registration from a client, the server further receiving from the client information that identifies a physical document;
wherein the server determines, based on the received information and the client registration, whether the client has rights to access an electronic copy of the identified physical document, and if the client has rights provides to the user access to the electronic document.

37. A method of extending information content of an image acquired from a printed item, comprising:
acquiring visual information from an area of the image,
accessing a database having stored therein a virtual rendition of the acquired image area or of the printed item associated with the visual information,
identifying in the database the virtual rendition, based on textual information in visual information, and
displaying the virtual rendition.

38. The method of claim 37, wherein displaying the virtual rendition includes overlaying the virtual rendition on the acquired image.

39. The method of claim 37, wherein the overlaid virtual rendition includes an active link specified in the database.

40. The method of claim 39, wherein activation of the active link causes an image from the database other than the virtual rendition to be displayed.

41. The method of claim 39, wherein activation of the active link causes at least one of a video clip, moving graphics, an audio track, a word definition, a web page, and tool tip to be displayed.

42. The method of claim 37, wherein the visual information is acquired by a line scanner, an electronic camera or camera from a mobile communication device, or a combination thereof.

43. The method of claim 37, wherein acquiring the visual information includes acquiring the visual information from a first area of the image and from a second area of the image, and wherein displaying the virtual rendition includes displaying a first virtual rendition corresponding to the first area and a second virtual rendition corresponding to the second area.

44. The method of claim 43, wherein the visual information from the first and second areas are acquired sequentially, and wherein displaying the first and second virtual renditions is synchronized with the acquisition of the first and second areas.

45. A method of extending information content of an image acquired from a printed item, the method comprising:
acquiring visual information from the item;
using the visual information, identifying in a database an electronic rendition of the image; and
displaying the electronic rendition.

46. A system for extending information content of an image acquired from a printed item, comprising:
an image acquisition device acquiring the image,
a database storing an electronic rendition of the image,
a processor identifying in the database the electronic rendition, based on textual information in the acquired image, and
a display displaying the electronic rendition.

47. A method for providing user access to electronic images of a physical text based on user ownership of the physical text, comprising:
(a) receiving a request for access to one or more electronic images of a physical text in which the request identifies the user submitting the request;
(b) confirming user ownership of the physical text based on the user identity;
(c) consulting one or more access rules that define an amount of content in electronic images of the physical text that can be provided to the user based on the user's ownership of the physical text, wherein the defined amount of content for users who own the physical text is greater than an amount of content that may otherwise be provided to users who do not own the physical text; and
(d) providing user access to the one or more electronic images of the physical text in accordance with the one or more access rules.

48. The method of claim 47, further comprising providing access to a user-personalized library of electronic content and automatically including the provided electronic images of the physical text in the user's personalized library for later access.

49. The method of claim 48, wherein automatically including the provided electronic images in the user's personalized library comprises storing a link in the user's personalized library, in which accessing the link provides the user access to the images in a centralized database of images.

50. The method of claim 48, further comprising setting a flag associated with the images in the user's personalized library to indicate that user ownership of the physical text has been confirmed.

51. The method of claim 47, wherein confirming user ownership comprises reviewing purchase information pertaining to the user and determining whether the user has purchased the physical text.

52. The method of claim 51, further comprising communicating with a third party regarding purchase information of the user.

53. The method of claim 47, wherein confirming user ownership comprises receiving from the user a receipt evidencing purchase of the physical text.

54. The method of claim 47, wherein confirming user ownership comprises receiving from the user an image of a page from the physical text.

55. The method of claim 47, wherein the one or more access rules permit user access to electronic images of the entire physical text.

56. The method of claim 47, wherein user ownership of the physical text results from the user's purchase of an item that the physical text normally accompanies.

57. The method of claim 56, wherein the physical text is an operating manual for the item purchased by the user.

58. A method for providing a central database with electronic images of physical texts and enabling access thereto by multiple users, comprising:
(a) acquiring images of pages of physical texts in which identifying information is associated with the images to identify the physical texts from which the images are acquired;
(b) storing the page images and the associated identifying information in the central database;
(c) receiving information indicating a user's ownership of a particular physical text; and
(d) enabling the user to access page images of the particular physical text in the central database based on the user's ownership of the physical text.

59. The method of claim 58, wherein acquiring images comprises scanning printed pages of a physical text.

60. The method of claim 58, wherein acquiring images comprises receiving page images and associated identifying information from a user upload.

61. The method of claim 60, wherein user-uploaded page images and associated identifying information are automatically included in a personalized library of electronic content maintained at the central database for the user.

62. The method of claim 58, wherein enabling the user to access page images comprises setting a flag associated with the user and the physical work in the central database signifying the user's ownership the physical text.

63. The method of claim 58, wherein receiving information indicating a user's ownership includes receiving information that the user has purchased the physical text.

64. Apparatus for providing user access to electronic images of a physical text based on user ownership of the physical text, comprising:
(a) means for receiving a request from a user to access one or more electronic images of a physical text, wherein the request identifies the user;
(b) means for confirming user ownership of the physical text based on the user's identity;
(c) means for consulting one or more access rules that define an amount of content in electronic images that can be provided to the user based on the user's ownership of the physical text, wherein the defined amount of content for users who own the physical text is greater than an amount of content that may otherwise be provided to users who do not own the physical text; and
(d) means for providing user access to the one or more requested electronic images in accordance with the one or more access rules.

65. The apparatus of claim 64, further comprising means for providing access to a user-personalized library of electronic content and automatically including the provided electronic images of the physical text in the user's personalized library for later access.

66. The apparatus of claim 64, further comprising means for setting a flag associated with the user and a physical text signifying the user's ownership of the physical text.

67. The method of claim 48, wherein receiving information indicating a user's ownership includes receiving information that the user has purchased as item normally accompanied by the physical text.

68. A computer implemented method, comprising:
processing a request from a user to access an electronic version of a physical work stored in a data storage, wherein the data storage has electronic versions of a physical works stored therein, the electronic versions of the physical works comprising images of the physical works that, when displayed to the user, appear the same as the physical works;
determining the user's ownership of the physical work; and
based on the user's ownership of the physical work, providing the user with access to the electronic version of the physical work.

69. The method of claim 68, wherein determining the user's ownership comprises reviewing purchase information pertaining to the user and determining whether the user has purchased the physical work.

70. The method of claim 69, further comprising communicating with a third party regarding purchase information of the user.

71. The method of claim 68, wherein determining the user's ownership comprises receiving from the user a receipt evidencing purchase of the physical work.

72. The method of claim 68, wherein determining the user's ownership comprises receiving from the user an image of a page from the physical work.

73. The method of claim 68, wherein the user's ownership of the physical work entitles the user to access the electronic version of the entire physical work.

74. The method of claim 68, wherein the user's ownership of the physical work results from the user's purchase of an item that the physical work normally accompanies.

75. A method for electronically searching a user-personalized library of content, comprising: (a) receiving one or more search terms from a user having an electronically-searchable personalized library of content; (b) electronically searching the full text of the user's personalized library for pages of content that match the search terms to produce search results; (c) providing the search results to the user; (d) receiving a search result selection from the user; and (e) providing to the user an image of a page of content in the user's personalized library based on the user's search result selection.

76. The method of claim 75, further comprising, prior to receiving one or more search terms from the user, establishing an electronically-searchable library of content that includes a page image database and a text searchable database, which library of content is personalized by the user to consist of content selected by the user.

77. The method of claim 76, in which the library of content is personalized by manual selection of content by the user.

78. The method of claim 76, in which the library of content is automatically personalized based on user selection of content for review or purchase.

79. The method of claim 75, in which the user-personalized library of content is established at the time the user conducts the search.

80. The method of claim 75, in which the user's personalized library of content is derived from a publicly-accessible general library of content.

81. The method of claim 75, in which providing the search results to the user includes providing a list of content having pages with text that matches the search terms.

82. The method of claim 81, further comprising ranking the content in the list of content according to a predetermined criterion.

83. The method of claim 75, in which providing to the user an image of a page of content includes retrieving the page image from a database of page images stored in computer memory.

84. The method of claim 75, in which the user's personalized library is defined after electronically searching a general library of content using the search terms, the user's personalized library being fully contained within the general library of content and defining the scope of search results provided to the user.

85. The method of claim 75, further comprising: (a) providing location information to the user that identifies the location of the search terms in the page image; and (b) instructing an electronic application of highlight to the page image by the user in accordance with the location information to highlight the search terms in the page image.

86. The method of claim 85, in which the electronic application of highlight to the page image comprises application of a layer of color on or near the search terms.

87. The method of claim 85, in which the electronic application of highlight to the page image comprises placement of a visual indicator next to the search terms.

88. The method of claim 75, further comprising using one or more access rules to limit an amount of content in one or more page images provided to the user.

89. The method of claim 88, in which the access rules define an aggregate amount of content that can be provided to the user over a time frame.

90. The method of claim 88, in which the access rules define a percentage of content that can be provided to the user over a time frame.

91. The method of claim 88, in which the access rules define the amount of content that can be provided to the user based on content-specific information.

92. The method of claim 88, in which the access rules define the amount of content that can be provided to the user based on user ownership of the content.

93. The method of claim 92, further comprising reviewing purchase records to validate user ownership of the content.

94. The method of claim 88, in which different access rules apply based on the location of the user.

95. The method of claim 88, in which different access rules apply based on the time the content is to be provided to the user.

96. The method of claim 88, in which the access rules define the amount of content that can be provided to the user based on an identification of the user.

97. The method of claim 75, in which a non-text object in the user's personalized library is made searchable by including text data related to the object in the electronic search.

98. A method for preparing a user-personalized library of content for electronic searching, comprising: (a) acquiring a general library of content that includes images and corresponding text of pages of content; (b) preparing a page image database comprised of the images of pages of content; (c) preparing a text searchable database comprised of the corresponding text of pages of content; and (d) receiving from a user a selection of content in the general library to form a user-personalized library of content that the user can electronically search using the text searchable database.

99. The method of claim 98, further comprising defining classes of content and assigning content in the user's personalized library to one or more of the classes.

100. The method of claim 99, further comprising limiting a search of the user's personalized library to content in a specified class.

101. The method of claim 98, in which the personalized library of content is comprised of content selected by a group of persons constituting a user, the method further comprising enabling persons in the group to conduct searches of the personalized library of content.

102. The method of claim 98, in which the user's selection of content in the general library is received based on manual selection by the user.

103. The method of claim 98, in which the user's selection of content in the general library is automatically received based on a selection of content by the user for review or purchase.

104. The method of claim 98, further comprising storing the user-personalized library of content in a memory for later retrieval by the user.

105. The method of claim 104, further comprising enabling the user to store and retrieve multiple user-personalized libraries.

106. The method of claim 98, in which the user's selection of content in the general library is aided by providing the user with a list of content determined to be related to a subject content.

107. A computer system that provides electronic searching of a user-personalized library of content, comprising a search server in communication with a database server, in which the database server is configured with a general library of content that is accessible to multiple users, the general library including (1) a page image database containing images of pages of content and (2) a text searchable database containing text and identifying information indicating the page images in the page image database that contain the text, the search server being configured with a search engine comprised of computer-implemented instructions that enable the search server to receive one or more search terms from a user having established a personalized library within the general library of content, search the full text of the user's personalized library for pages of content that match the search terms, provide the results of the full text search to the user for selection by the user, and provide to the user a page image from the page image database based on the user's search result selection.

108. The computer system of claim 107, further comprising an access rights database in the database server with access rules that limit the amount of content in the page image that is provided to the user.

109. The computer system of claim 108, in which the access rules define an aggregate amount of content that can be provided to the user over a time frame.

110. The method of claim 108, in which the access rules define a percentage of content that can be provided to the user over a time frame.

111. The method of claim 108, in which the access rules define the amount of content that can be provided to the user based on content-specific information.

112. The computer system of claim 108, in which the access rules define the amount of content that can be provided to the user based on user ownership of the content.

113. The computer system of claim 112, in which the computer-implemented instructions further enable the search server to validate user ownership of the content by reviewing purchase records pertaining to the user.

114. The computer system of claim 108, in which different access rules apply based on the location of the user.

115. The computer system of claim 108, in which different access rules apply based on the time the content is to be provided to the user.

116. The computer system of claim 108, in which the access rules define the amount of content that can be provided to the user based on an identification of the user.

117. The computer system of claim 107, in which a non-text object in the user's personalized library is made searchable by including text data related to the object in the text searchable database.

118. The computer system of claim 107, in which the search server provides the search results in the form of a list of content having pages with text that matches the search terms, which content in the list of content is ranked according to a predetermined criterion.

119. The computer system of claim 107, in which the computer-implemented instructions further enable the search server to provide location information to the user that identifies the location of search terms in the page image and instruct an electronic application of highlight to the page image by the user in accordance with the location information to highlight the search terms in the page image.

120. The computer system of claim 119, in which the electronic application of highlight to the page image comprises application of a layer of color on or near the search terms.

121. The computer system of claim 119, in which the electronic application of highlight to the page image comprises placement of a visual indicator next to the search terms.

122. A method for identifying a printed page based on textual information acquired from the printed page, the method comprising:
selecting from the information first and second words,
comparing the words with text in electronic documents that include a virtual rendition of the page, and
identifying, based on the comparing, a document that includes the printed page.

123. The method of claim 122 further comprising when the first and second words have first and second positions, respectively, determining the first and second positions.

124. The method of claim 123 wherein determining the first and second positions comprises determining an organization of the selected words.

125. The method of claim 123 wherein determining the first and second positions comprises determining an order of the selected words on the page.

126. The method of claim 123 wherein determining the first and second positions comprises determining a spatial relationship between the selected words.

127. The method of claim 126 wherein determining the spatial relationship comprises determining spatial coordinates of the selected words in at least a portion of the printed page.

128. The method of claim 126 wherein determining the spatial relationship comprises determining spatial coordinates of the selected words in the printed page.

129. The method of claim 123 wherein comparing includes comparing the positions of the words with text in the electronic documents.

130. The method of claim 122 wherein selecting comprises assigning to each of the first and second words a respective significance.

131. The method of claim 130 wherein assigning a significance comprises determining a frequency of a word from reference information that includes word frequency information.

132. The method of claim 131 wherein the reference information is a dictionary.

133. The method of claim 130 wherein:
the information is presented using an alphabet of a language;
each letter of the alphabet has an estimated frequency of occurrence; and
the significance assigned to a word depends on the estimated frequency of a letter in the word.

134. The method of claim 130 wherein assigning a significance comprises determining a word-length of at least one of the words.

135. The method of claim 134 wherein only a word having a word-length greater than a predetermined value is significant.

136. The method of claim 134 wherein the word-length of at least one of the words is defined by the number of letters in the word.

137. The method of claim 130 further comprising assigning a significance to a third word wherein the selecting is based on comparing the significances of the first, second, and third words.

138. The method of claim 137 wherein, when the first and second words have first and second positions, respectively, the comparing includes comparing the first and second positions in the electronic documents.

139. The method of claim 122 wherein identifying the document includes receiving metadata corresponding to the document.

140. The method of claim 122 wherein the textual information is acquired from an image of at least a portion of the printed page.

141. A system for identifying a printed page comprising:
a first processing module for acquiring textual information from the printed page,
a second processing module for selecting from the information first and second words,
a third processing module for performing a comparison of the words with text in electronic documents that include a virtual rendition of the page, and
a fourth processing module for identifying, based on the comparison, a document that includes the printed page.

142. The system of claim 141 further comprising a receiver for receiving an image of the printed page, wherein the first processing module is configured to acquire textual information from the image.

143. The system of claim 141 further comprising an image capture device for capturing an image of the printed page, wherein the first processing module is configured to use the image to acquire textual information.

144. A computer program, disposed on a computer readable medium, for identifying a printed page based on textual information acquired from the printed page, the computer program including instructions for causing a processor to:
select from the information first and second words,
compare the words with text in electronic documents that include a virtual rendition of the page, and
identify, based on comparing, a document that includes the printed page.

145. A system for document retrieval and/or indexing comprising:
a component that receives a captured image of at least a portion of a physical document; and
a search component that locates a match to the document, the search is performed over word-level topological properties of generated images, the generated images being images of at least a portion of one or more electronic documents.

146. The system of claim 145, further comprising a component that generates signature(s) corresponding to one or more of the generated images and generates a signature corresponding to the captured image of the document, the signatures identify the word-layout of the generated images, and the search performed via comparing the signatures of the generated images with the signature of the image of the captured document.

147. The system of claim 146, the signatures corresponding to the one or more generated images and the signature of the image of the captured document are generated at least in part upon a location of at least a portion of each word in the generated images and the image of the captured document, respectively.

148. The system of claim 145, further comprising a component that reduces noise in the captured image of the document.

149. The system of claim 145, further comprising a component that generates a grayscale image of the captured image of the document.

150. The system of claim 145, further comprising a caching component that automatically generates an image of an electronic document at a time such electronic document is printed.

151. The system of claim 150, further comprising an artificial intelligence component that infers which printed documents should have associated stored images.

152. The system of claim 145, wherein at least one of the generated images is associated with an entry within a data store, the entry comprising one or more of an image of a page of an electronic document and a signature that identifies the image of the page, the signature based at least in part upon topological properties of words within the image of the page.

153. The system of claim 152, the one or more of the image of the page of the electronic document and the signature that identifies the image of the page associated with a URL that identifies a location of the electronic document.

154. The system of claim 152, the one or more of the image of the page of the electronic document and the signature that identifies the image of the page associated with the electronic document.

155. The system of claim 152, the one or more of the image of the page of the electronic document and the signature that identifies the image of the page associated with OCR of the image of the page.

156. A method that facilitates indexing and/or retrieval of a document, comprising:
receiving a captured image of at least a portion of a document; and
searching data store(s) for an electronic document corresponding to the captured image, the search performed via comparing topological word properties within the captured image with topological word properties of generated images corresponding to a plurality of electronic documents.

157. The method of claim 156, further comprising reducing noise in the captured image of the document prior to searching the data store(s).

158. The method of claim 157, wherein reducing noise comprises one or more of: providing a filter that removes markings that have a width greater than a threshold width; providing a filter that removes markings with a width less than a threshold width; providing a filter that removes markings with a height greater than a threshold height; and providing a filter that removes marking with a height less than a threshold height.

159. The method of claim 156, further comprising generating a grayscale image of the captured image of the document prior to searching the data store(s).

160. A system for indexing and/or retrieval of a document, comprising:
means for generating an image of an electronic document when the electronic document is printed;
means for capturing an image of the document after the document has been printed;
means for retrieving the electronic document, the means based at least in part upon comparing location and width of words within the captured image to the location and width of words within the generated image.

161. The system of claim 160, further comprising: means for generating a signature that includes features that are highly specific to the generated image; and means for generating a signature corresponding to the captured image, the signature includes features that are highly specific to the captured image.

162. The system of claim 160, further comprising: means for generating a signature that includes features that are specific to the generated image; and means for generating a signature corresponding to the captured image, the signature includes features that are specific to the captured image.

163. The system of claim 162, wherein the features include the spatial coordinates of the words.

164. The system of claim 162, wherein the features include the order of the words.

165. The system of claim 161, further comprising means for accounting for error that occurs when capturing the image of the printed document.

166. The system of claim 162, further comprising means for accounting for error that occurs when capturing the image of the printed document.

167. A system that facilitates indexing and/or retrieval of a document, comprising:
a query component that receives an image of a printed document;
a caching component that generates and stores an image corresponding to the image of the document prior to the query component receiving the image of the printed document; and a comparison component that retrieves the stored image via comparing at least one of location and width of words within the stored image to location and width of words within the image of the printed document.

168. A computer readable medium having computer executable instructions stored thereon to return stored image(s) of an electronic document to a user based at least in part upon topological word properties of captured image(s) corresponding to the printed document.

169. A computer readable medium having a data structure thereon, the data structure comprising:
a component that receives image(s) of at least a portion of a printed document; and
a search component that facilitates retrieval of an electronic document, the electronic document corresponding to the image(s) of the printed document, the retrieval based at least in part upon similar word-level topological properties when comparing the image(s) of the printed document and generated image(s) of the electronic document.

170. A personal digital assistant comprising the system of claim 145.
